(19) United States
(12) Patent Application Publication
(10) Pub. No.: US 2005/0110756 A1
(43) Pub. Date: May 26, 2005

(54) Device and method for controlling symbols displayed on a display device

(76) Inventors: Bernard J. Hall, Elizabeth, NJ (US); William Liao, Melbourne (AU)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/995,784

(22) Filed: Nov. 22, 2004

Related U.S. Application Data
(60) Provisional application No. 60/524,170, filed on Nov. 21, 2003.

(51) Int. Cl. G09G 5/08

(52) U.S. Cl. 345/161

(57) ABSTRACT

A device for controlling keyboard keys displayed on a display. A three dimensional position sensing device is used to locate a pointing object such as a finger tip hovering over a display screen. A processor moves the displayed keys in corresponding x and y directions responsive to the two dimensional location of the finger tip. The processor also increases or decreases the size of a portion of the displayed keys depending on whether the finger tip is moving toward or away from the display in the z-direction in order to assist the user in navigating a full keyboard in a small display.

### CROSS REFERENCE TO RELATED APPLICATIONS

This application claims priority under 35 U.S.C. §119 (e) to U.S. provisional patent application No. 60/524,170, filed Nov. 21, 2003, which is hereby incorporated by reference.

### FIELD OF THE INVENTION

The present invention relates to a position sensing input device and more particularly, to a position sensing input device for controlling symbols displayed on a display.

### BACKGROUND OF THE INVENTION

Pointing devices such as keyboard, thumb pad, thumb wheel and touch pad devices are used to move a cursor on a display to navigate through displayed symbols or keys. These conventional pointing devices also work well in small portable devices such as mobile telephones or hand held electronic devices with relatively smaller displays so long as there are only a few displayed symbols to be navigated. However, when a large number of symbols such as a full keyboard need to be navigated on the display, conventional pointing devices cannot be used because the small display size does not normally allow the full set of keyboard symbols to be displayed at one time.

Thus, there is a need to provide an improved input pointing device that allows navigation through a large number of symbols in a relatively small display.

### SUMMARY OF THE DISCLOSURE

According to the invention, a device for controlling symbols, such as keyboard keys, displayed on a display is provided. A three dimensional position sensing device is used to three dimensionally locate a pointing object such as a finger tip hovering over a display. A processor moves the displayed keys in corresponding x and y directions responsive to the two dimensional location of the finger tip. The processor also increases or decreases the size of a portion of the displayed keys depending on whether the finger tip is moving toward or away from the display in the z-direction in order to assist the user in navigating a full keyboard in a small display. In other words, the processor zooms in or out on the displayed keys according to the vertical position (z-direction) of the finger tip.

In another aspect of the invention, a control zone within the display is defined. When the finger tip is inside the control zone, the processor freezes or stops the movement of the displayed keys in the x and y direction. When the x and y position of the finger tip is outside the control zone, processor moves the displayed symbols in the corresponding x and y direction at a speed which is based on how far away the pointing object is from the control zone in the x and y direction. This feature may be useful when the display is very small and movement of the finger tip across the display is insufficient to move the entire keyboard across the display.

### BRIEF DESCRIPTION OF THE DRAWINGS

FIG. 1 is a functional block diagram of the control device according to the present invention.

FIG. 2 illustrates a mobile telephone and a hand held PDA or game device to which the control device may be incorporated.

FIGS. 3A and 3B are a set of screen/display images that illustrate the change in displayed symbols according to the movement and location of a pointing object.

FIGS. 4A and 4B illustrate control zones defined within a display.

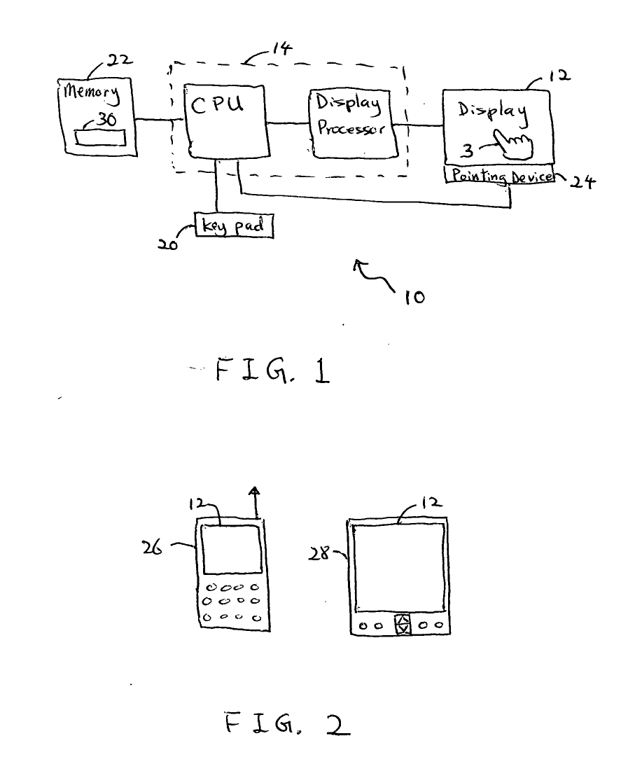

### DETAILED DESCRIPTION OF THE INVENTION

According to the principles of the present invention, a display control device 10 includes a display 12 and a processor 14 comprised of a CPU 16 and a display processor 18. A keypad/keyboard 20 and memory 22 are connected to the processor 14.

The display 12 can be any screen capable of displaying graphics such as LCD, CRT, LED or the like. The memory 22 stores display control software programs 30 that control the display of symbols as a function of the x, y and z inputs from the three dimensional position sensing device 24.

The three dimensional position sensing device 24 attached to the display is connected to the CPU 16. The position sensing device 24 has x, y, and z outputs that provide a three dimensional position of a pointing object 3 such as a user's finger tip positioned above the display 12. The x, y and z outputs vary as a function of the finger tip position above the display 12. The position sensing device 24 can be any conventional three dimensional position sensing device. For example, the position sensing device 24 can be a capacitive sensor as disclosed in International Application Number PCB/IB2002/002494, entitled “Apparatus for Sensing the Position of a Pointing Object”, published on Jan. 16, 2003, which is incorporated herein by reference. It can also be a sensing device as disclosed in a U.S. patent application entitled “Three Dimensional Position Sensing Apparatus and Method for a Display Device”, (attorney docket P-6/555675.______), being filed on the same day with the present application, which is also incorporated herein by reference.

As shown in FIG. 2, the display control device 10 is particularly useful when incorporated into small hand held electronic devices such as a mobile telephone 26, PDA (personal digital assistant) 28 or game device 28 which tend to have relatively small displays.

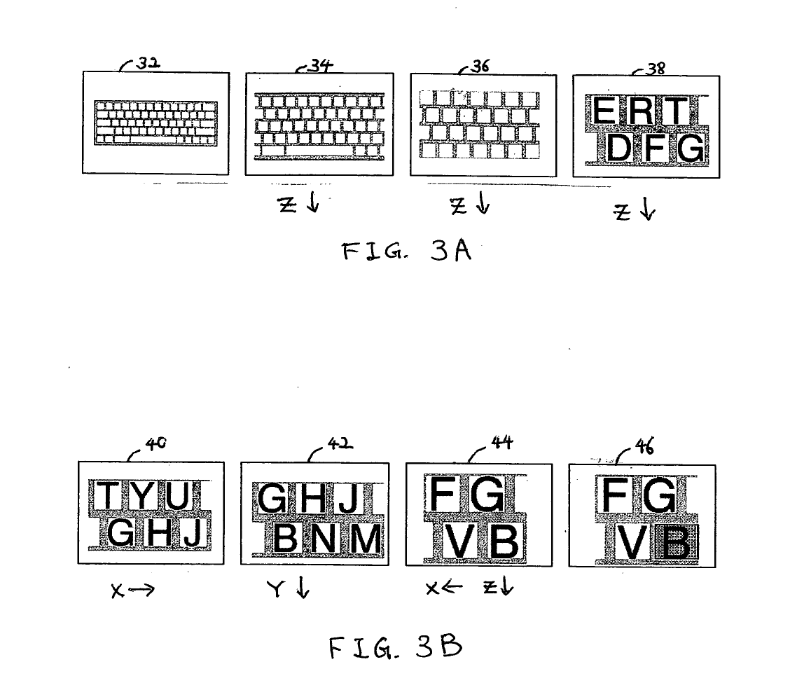

FIG. 3 includes a series of screen/display images that illustrate the change in display of the symbols. Initially, the display 12 displays a plurality of symbols which represent user selectable keys in a typical keyboard as shown in image 32. When a user brings his finger above the display 12 and starts to lower it vertically (as shown in image 34), the position sensing device 24 senses the motion and outputs a signal on x, y and z outputs which indicate that the user's finger is vertically moving closer to the display. The processor 14, under control of the software program 30, zooms in on the portion of the keyboard symbols which is closest to the pointing finger as shown in image 34. In other words, the display processor 18 increases the size of the keyboard portion closest to the pointing finger. As the user continues to move the pointing finger down (image 36, then image 40), the processor 14 through the display processor 18 continues to increase the size of the keyboard portion closest to the pointing finger. In image 38, the user can now clearly see the letter symbols being displayed.

Image 40 represents the display image when the user's finger moves to the right in the x-direction; image 42 represents the display image when the user's finger moves down in the y-direction; image 44 represents the display image when the user's finger simultaneously moves left in the x-direction and down in the z-direction which results in an increase in the size of the displayed symbols. Finally, image 46 represents detection of the user's selection of the “B” key. The processor 14 highlights the selected key, e.g., reverse video and a box around the selected key in the image shown.

The detection of the user selection can be done in different ways. In one way, the processor detects the user selection when the z-output indicates that the user's finger tip is within a predetermined distance from the display in the z-direction. The symbol selected is the closest displayed key to the x and y position of the finger tip. In another way, the processor determines user selection of a key when the z output indicates that the finger tip is moving toward the display 12 at a faster speed than a predetermined speed.

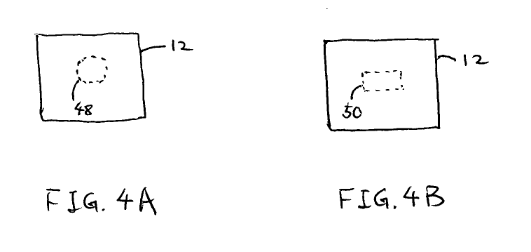

In one embodiment, the display 12 has a two dimensional control zone 48, 50 such that when the user's x and y finger tip position is inside the zone, the displayed symbols do not move in the x or y direction. As shown in FIGS. 4A and 4B, the zone can be of a circular shape 48, rectangular shape 50 or the like. When the pointing object 3 is outside the control zone 48, the displayed symbols move at a speed that is dependent on how far away the pointing object 3 is from the zone. The further away from the zone, the faster the displayed symbols move.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

1. A device for controlling symbols displayed on a display, comprising:
a position sensing device having x, y and z outputs that correspond to the three dimensional position of a pointing object positioned above a display;
a processor connected to the x, y and z outputs of the position sensing device and operable to display a plurality of symbols on the display, the processor further operable to:
move the displayed symbols in corresponding x and y directions responsive to the x and y inputs; and
change the size of a portion of the displayed symbols in response to the z output.

2. The device according to claim 1, wherein the symbols are keyboard keys and when the processor receives from the z output an indication that the pointing object is moving closer to the display, the processor increases the size of those keys that are closer to the x and y location of the pointing object.

3. The device according to claim 1, wherein the symbols are keyboard keys and when the processor receives from the z output an indication that the pointing object is within a predetermined distance from the display in the z-direction, the processor selects the closest displayed key to the pointing object.

4. The device according to claim 3, wherein the processor highlights the selected key on the display.

5. The device according to claim 1, wherein the symbols are keyboard keys and the processor determines user selection of one of the displayed keys when the processor receives from the z output an indication that the pointing object is moving toward the display in the z-direction at a faster speed than a predetermined speed.

6. The device according to claim 1, wherein the device for controlling symbols is incorporated into a mobile telephone device, a hand held personal digital assistant or a hand held game device.

7. The device according to claim 1, wherein:
a control zone within the display is defined; and
when the x and y position of the pointing object is within the control zone, the processor freezes movement of the displayed symbols in the x and y direction.

8. The device according to claim 7, wherein when the x and y position of the pointing object is outside the control zone, the processor moves the displayed symbols in the corresponding x and y direction at a speed which is based on how far away the pointing object is from the control zone in the x and y direction.

9. The device according to claim 7, wherein the symbols are keyboard keys and when the processor receives from the z output an indication that the pointing object is moving closer to the display, the processor increases the size of those keys that are closer to the x and y location of the pointing object.

10. The device according to claim 7, wherein the symbols are keyboard keys and when the processor receives from the z output an indication that the pointing object is within a predetermined distance from the display in the z-direction, the processor selects the closest displayed key to the pointing object.

11. The device according to claim 10, wherein the processor highlights the selected key on the display.

12. The device according to claim 7, wherein the symbols are keyboard keys and the processor determines user selection of one of the displayed keys when the processor receives from the z output an indication that the pointing object is moving toward the display in the z-direction at a faster speed than a predetermined speed.

13. A device for controlling keyboard keys displayed on a display, comprising:
a position sensing device having x, y and z outputs that correspond to the three dimensional position of a pointing object positioned above the display, the pointing object being a body part of a user;
a processor connected to the x, y and z outputs of the position sensing device and operable to display a plurality of symbols on the display, the processor further operable to:
move the displayed symbols in corresponding x and y directions responsive to the x and y inputs; and
increase the size of a portion of the displayed symbols which correspond to the x and y location of the pointing object when the processor receives from the z output an indication that the pointing object is moving closer to the display.

14. The device according to claim 13, wherein the symbols are keyboard keys and when the processor receives from the z output an indication that the pointing object is moving closer to the display, the processor increases the size of those keys that are closer to the x and y location of the pointing object.

15. The device according to claim 13, wherein:
a control zone within the display is defined; and
when the x and y position of the pointing object is within the control zone, the processor freezes movement of the displayed keyboard keys in the x and y direction.

16. The device according to claim 15, wherein when the x and y position of the pointing object is outside the control zone, the processor moves the displayed symbols in the corresponding x and y direction at a speed which is based on how far away the pointing object is from the control zone in the x and y direction.

17. A method of controlling symbols displayed on a display using a three dimensional position sensing device having x, y and z outputs, comprising:
displaying on a display a plurality of symbols;
receiving x, y and z outputs from a position sensing device, the x, y and z outputs corresponding to the three dimensional position of a pointing object positioned above the display;
moving the displayed symbols in corresponding x and y directions responsive to the x and y inputs of the position sensing device; and
changing the size of a portion of the displayed symbols in response to the z output.

18. The method according to claim 17, wherein the symbols are keyboard keys, further comprising:
determining user selection of one of the displayed keys when the z output indicates that the pointing object is moving toward the display in the z-direction at a faster speed than a predetermined speed.

19. The method according to claim 17, further comprising:
freezing movement of the displayed symbols in the x and y direction when the x and y position of the pointing object is within a control zone defined inside the display.

20. The method according to claim 19, wherein when the x and y position of the pointing object is outside the control zone, and wherein the step of moving includes moving the displayed symbols in the corresponding x and y direction at a speed which is based on how far away the pointing object is from the control zone in the x and y direction.
